(19) United States
(12) Patent Application Publication
(10) Pub. No.: US 2025/0339719 A1
(43) Pub. Date: Nov. 6, 2025

(54) IN-RACK FIRE DETECTION AND EXTINGUISHING SYSTEM AND METHOD

(71) Applicant: FACTORY MUTUAL INSURANCE COMPANY, Johnston, RI (US)

(72) Inventors: Seth Sienkiewicz, Norwood, MA (US); Michael Racicot, West Glocester, RI (US); Michael Gravel, JR., West Glocester, RI (US)

(21) Appl. No.: 18/865,516

(22) PCT Filed: May 31, 2023
(86) PCT No.: PCT/US2023/023916

§ 371 Date: Nov. 13, 2024

Related U.S. Application Data
(60) Provisional application No. 63/347,387, filed on May 31, 2022.

(51) Int. Cl. A62C 37/44; A62C 3/00

(52) U.S. Cl. CPC A62C 37/44; A62C 3/002

(57) ABSTRACT

A fire detection and extinguishing system and method for early detection, extinguishing, and prevention of a fire in a rack storage system. The fire detection and extinguishing system may include a valve coupled to one or more discharge orifices, a control panel, and a linear heat detection system. The linear heat detection system may include one or more heat trace wires. The fire detection and extinguishing system may be configured to detect a fire in the storage rack system and discharge a fire extinguishing material from the one or more discharge orifices to extinguish the fire.

### TECHNICAL FIELD

The present application relates generally to a system for fire protection. More specifically, the present application relates to an in-rack system for fire detection and suppression.

### BACKGROUND

In warehouses, product may be stored in vertically stacked racks. Prior art fire protection systems (i.e., in-rack fire protection systems) for such arrangements involve substantial piping and sprinklers or nozzles. For example, where a rack is multiple levels high, each horizontal platform for holding product may also include a pipe running along the length of the platform with conventional sprinklers or nozzles dispersed along the pipe. The sprinklers are typically activated by fusing (e.g., a fusible element coupled to the sprinkler, similar to a trigger, is melted due to heat exposure, causing the sprinkler to actuate). These prior art systems result in permanent systems densely populated with sprinklers using high volumes of water to effectively extinguish fires.

### SUMMARY

According to an embodiment, a storage system may include a storage rack system; and a fire detection and extinguishing system, the fire detection and extinguishing system may include a valve coupled to one or more discharge orifices; and a heat detection system, wherein the fire detection and extinguishing system is configured to detect a fire in the storage rack system and discharge a fire extinguishing material from the one or more discharge orifices to extinguish the fire.

According to an embodiment, a fire detection and extinguishing system may include a control panel; one or more valves communicatively coupled to the control panel; one or more discharge orifices in fluid communication with the valve; and a linear heat detection system, wherein the linear heat detection system is configured to detect a fire and the one or more discharge orifices are configured to discharge a fire extinguishing material onto the fire.

According to an embodiment, a method for detection and extinguishing of a fire may include detecting heat from a fire with a linear heat detection system installed on one or more storage racks; and discharging a fire extinguishing material from one or more discharge orifices installed on the one or more storage racks based on the detected heat.

### BRIEF DESCRIPTION OF THE DRAWINGS

The foregoing aspects and other features and advantages of the invention will be apparent from the following drawings, wherein like reference numbers generally indicate identical, functionally similar, and/or structurally similar elements.

FIG. 1 is a perspective view of an in-rack storage system having a fire detection and extinguishing system, according to an embodiment.

FIG. 2 is a perspective view of a fire detection and extinguishing system, according to an embodiment.

FIG. 3 is a side view of an in-rack storage system having an extendable fire detection and extinguishing system, according to an embodiment.

FIG. 4 is a top view of an in-rack storage system having an extendable fire detection and extinguishing system, according to an embodiment.

FIG. 5 is a top view of an in-rack storage system having an extendable fire detection and extinguishing system with alternate routing, according to an embodiment.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without departing from the spirit and scope of the invention.

Compared to conventional systems, the inventors discovered that a need exists for an in-rack fire detection and extinguishing system with reduced piping, reduced water usage, reduced cost, and earlier detection that is not permanently installed. The need also exists, in some embodiments, for a permanently installed in-rack fire detection and extinguishing system.

Embodiments of the present invention relate to an in-rack system aimed at reducing the amount of piping and sprinklers provided on the racks, as well as reducing the amount of water discharged to extinguish a fire. The in-rack system of the present disclosure includes a control system and linear heat detection placed throughout the rack system. The linear heat detection is used in place of conventional fusible elements to actuate discharge orifices in the proximity of a fire. The linear heat detection may be installed in very tight spaces within the rack system, both horizontally and vertically, allowing fire detection very early in the fire growth. The linear heat detection may comprise one or more cables (described below) that run horizontally along the racks. Valves are included in the piping to allow for a fire extinguishing material to be directed to a particular valve or sprinklers in the area where a fire is detected by the linear heat detection. During operation, the linear heat detection system may send a signal to the control system indicating a fire is present in a particular area of the warehouse or rack system. The control system may in turn send a signal to the valves in the vicinity of the fire to open and allow the fire extinguishing material to flow to the sprinklers and extinguish the fire. Thus, as may be appreciated, the system may be a zonal system allowing detection and protection in zones of a rack storage system.

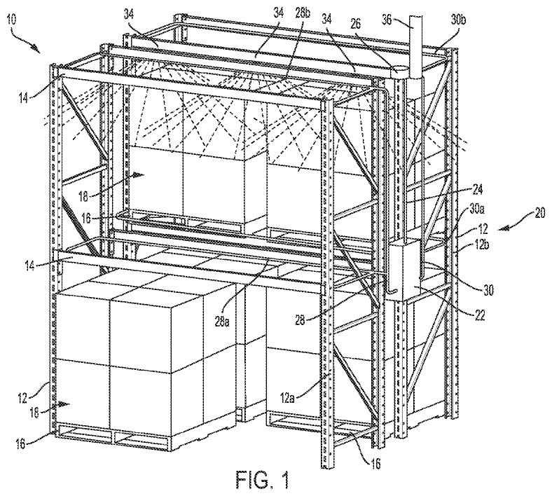

Referring to FIG. 1, a storage rack system 10 is shown. The storage rack system 10 may include a frame 12 and one or more shelves 14. The one or more shelves 14 may be coupled to the frame 12 at one or more notches. The notches may allow for the shelves 14 to be provided at any number of vertical heights to accommodate a variety of heights of containers, boxes, or products 18. The pallets 16 may be placed on the floor and/or on one or more of the shelves 14. In some embodiments, the pallets 16 may not be used at all. The storage rack system 10 may allow for vertical storage of a product.

The storage rack system 10 may include a forward frame 12a and a rear frame 12b. The forward frame 12a and the rear frame 12b may be the same as described previously with respect to frame 12. The storage rack system 10 may include a system 20. The system 20 may be a fire detection and extinguishing system. The system 20 may detect and extinguish fires in the storage rack system 10. The system 20 may suppress fires and may prevent the spreading of fires due to the detection and extinguishing of the fire. The system 20 may be coupled to the forward frame 12a and the rear frame 12b. A plurality of storage rack systems 10 including a forward frame 12a, rear frame 12b, and system 20 may be provided in a building or warehouse. The plurality of storage rack systems 10 may be the same or similar and may allow for storage of a plurality of products or goods within a building or warehouse. When a plurality of storage rack systems 10 are provided in a building or warehouse, the systems 20 may be coupled to one another and/or to a central control system. Thus, the plurality of systems 20 associated with each of the plurality of storage rack systems 10 may provide a fire detection and extinguishing system for the entire building or warehouse.

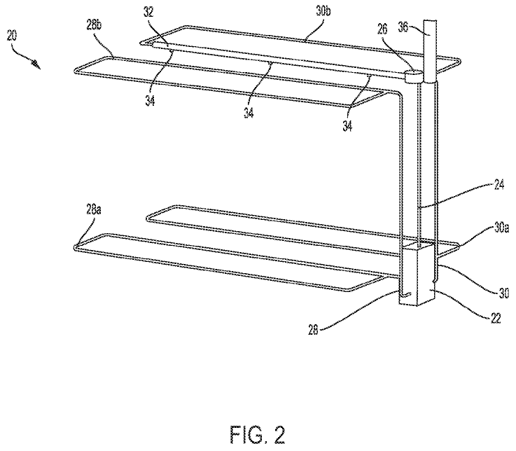

With reference to FIGS. 1 and 2, the system 20 may include a control panel 22 and a linear heat detection system. The control panel 22 may be coupled to each of the forward frame 12a, the rear frame 12b, and the linear heat detection system. The linear heat detection system may send a signal to the control panel. The signal may be an electrical short. The linear heat detection system may include a first heat trace wire 28 and a second heat trace wire 30. In some embodiments, the system may include additional heat trace wires. The first heat trace wire 28 may extend along the forward frame 12a. The second heat trace wire 30 may extend along the rear frame 12b. The first heat trace wire 28 and the second heat trace wire 30 may be electrically and communicatively coupled to the control panel 22. The first heat trace wire 28 and the second heat trace wire 30 may allow for linear heat detection within the storage rack system 10. The first heat trace wire 28 and the second heat trace wire 30 may sense or react to the heat present (e.g., due to a fire) and send a signal to the control panel 22.

The first heat trace wire 28 may include a first lower heat trace wire 28a and a first upper heat trace wire 28b. The first lower heat trace wire 28a may extend along some or all of the inner perimeter of a lower shelf 14 of the forward frame 12a. The first upper heat trace wire 28b may extend along some or all of the perimeter of an upper shelf 14 of the forward frame 12a. The second heat trace wire 30 may include a second lower heat trace wire 30a and a second upper heat trace wire 30b. The second lower heat trace wire 30a may extend along some or all of the inner perimeter of a lower shelf 14 of the rear frame 12b. The second upper heat trace wire 30b may extend along some or all of the perimeter of an upper shelf 14 of the rear frame 12b. The first heat trace wire 28 and the second heat trace wire 30 may extend along an inner side of the walls of the shelves 14 so as not to interfere with or be damaged by product 18 and/or pallets 16 located on or near the shelves 14.

In some embodiments, the first heat trace wire 28 and the second heat trace wire 30 may be the same wire. In some embodiments, upper heat trace wires 28a and 30a may be combined with the lower heat trace wires 28b and 30b into a single wire.

The system 20 may include a signal wire 24. The signal wire 24 may extend between the control panel 22 and one or more valves 26. The signal wire 24 may be electrically and communicatively coupled with the control panel 22 and the one or more valves 26. The signal wire 24 may communicate instructions from the control panel 22 to the valve 26 for opening, closing, partially-opening, and/or partially-closing the valve 26. The valve 26 may be coupled between a supply line extension 36 and a branch line 32. The valve 26 may be in a normally closed position. The valve 26 may selectively permit or prohibit communication of a fire extinguishing material from the supply line extension 36 to the branch line 32. The supply line extension 36 may be coupled to a main supply source, such as a main water source or dry chemical or wet chemical storage tank. The main supply source may house or store a fire extinguishing material, such as a fire extinguishing fluid or other fire extinguishing material. The fire extinguishing material may be a water, a wet chemical, or a dry chemical, clean agent or CO2. The valve 26 may be opened or partially opened to allow the fire extinguishing material from the main supply source to flow through the supply line extension 36, through the valve 26, and through the branch line 32 to one or more discharge orifices 34. The discharge orifices 34 may be sprinkler heads, nozzles, and/or other orifices for discharging the fluid from the main supply source. The discharge orifices 34 may include valves or control devices for allowing selective opening and/or closing of the discharge orifices 34 based on signals received from the control panel 22.

As shown in FIGS. 1 and 2, the system 20 may include a heat trace wire 28, 30 for each shelf 14. The system 20 may include one branch line 32 coupled to the one or more discharge orifices 34 and the one or more valves 26 at the upper shelf 14. The number of branch lines 32, discharge orifices 34, and valves 26 may be selected based on the desired coverage of the fire detection and extinguishing system. That is, if it is determined optimal or desired coverage is vertically approximately every 30 feet and a shelf 14 is provided approximately every 10 feet, then every third shelf 14 may include the branch line 32 and discharge orifices 34, while every shelf 14 may include a heat trace wire. In the exemplary embodiment of FIGS. 1 and 2, the branch line 32, discharge orifices 34, and valve 26 are provided every second shelf. Accordingly, if the frame 12 of FIG. 1 includes four shelves, there would be a branch line 32, discharge orifice 34, and valve 26 on both the second shelf and the fourth shelf.

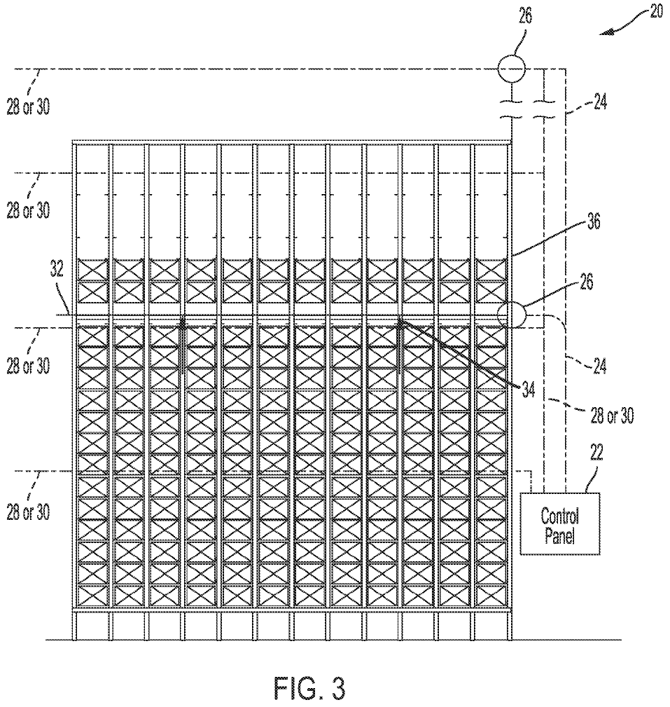

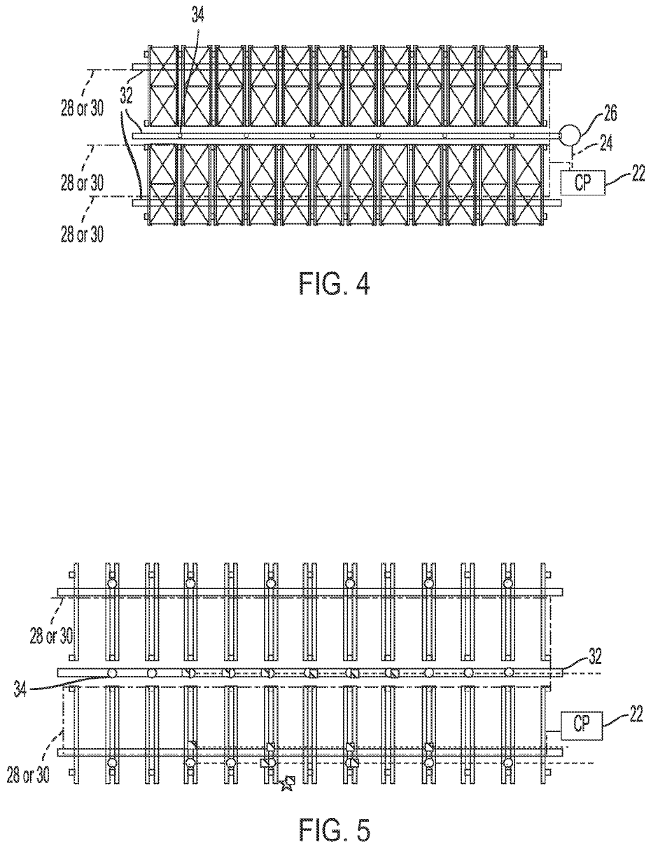

Referring to FIGS. 3 and 4, the system 20 may be coupled with a plurality of storage rack system types. The system 20 may be extendable to integrate into a plurality of storage rack sizes (e.g., heights, widths) and types (multiple racks, no racks, tightly spaced racks). In some embodiments, the system 20 may be extendable to couple with the ceiling of the warehouse or building, in addition to a storage rack system. For storage rack systems that are closely spaced, or house items that are closely spaced, the system 20 may use alternate sprinkler or nozzle types to operate in tight spaces (e.g., no-face sprinklers or nozzles). In some embodiments, alternate sprinkler or nozzle types may be used to distribute the fire extinguishing material in a directed or directional manner. FIG. 4 illustrates how, in some embodiments, the branch line 32 may be placed both between the storage rack systems 10 and within the storage rack systems 10. This method of branch line 32 and sprinkler or nozzle placement may, in some embodiments, allow for better targeting of fires.

Referring to FIG. 5, the system 20 may be equipped with an alternative linear heat detection system wiring. The linear heat detection system may be wired in a plurality of different ways. In one embodiment, depicted in FIG. 5, the linear heat detection system may be coupled with the storage rack system 20 in a snaking manner, where the heat trace wires 28 and 30 pass through a first rack system to a second rack system in the storage rack system 20. In some embodiments, the heat trace wires 28 and 30 may be a single wire per rack level that passes through both storage racks. In other embodiments, the heat trace wires 28 and 30 may be separate heat trace wires that run alongside each other through the first rack, and where only the second heat trace wire 30 passes through the second rack system. Having two separate heat trace wires may provide the benefit of localized fire detection for each rack system. In some embodiments, having a single longer heat trace wire may provide a cost benefit over multiple heat trace wires.

In operation, a plurality of storage rack systems 10 may be provided in a warehouse or building, each including the fire detection and extinguishing system 20. In the event of a fire in a particular storage rack system 10 of the plurality of storage rack systems 10, the system 20 of the storage rack system 10 where the fire is occurring may be activated. In the storage rack system 10 where the fire is present, the heat trace wires 28, 30 may sense the heat from the fire and send a signal to the control panel 22. The control panel 22 may send a signal on signal wire 24 to the valve 26. The signal may instruct the valve 26 to open, thus allowing fire extinguishing material to flow from a main supply source, through the supply line extension 36, through the valve 26, through the branch line 32, and to each of the discharge orifices 34. The fire extinguishing material may be discharged through the discharge orifices 34 onto the storage rack system 10 and fire. When the fire is extinguished, the valve 26 may be manually closed and/or may be automatically closed by a signal sent from the control panel 22 through the signal wire 24. The system may include one or more sensors (e.g., heat, optical, smoke sensors) to detect when the fire is extinguished and, in some embodiments, may an option to send a signal to the control panel 22 to close the valve(s) 26.

The fire detection and extinguishing system 20 of the foregoing disclosure may be retrofitted into an existing storage rack system. The fire detection and extinguishing system 20 may be moved within a building, warehouse or storage facility. Accordingly, the fire detection and extinguishing system 20 may allow for a modular storage rack system 10. The frames 12 of the storage rack system 10 may be moved and modified within the building to allow for storage of a particular product and the system 20 may be installed after movement of the frames 12. This may allow for a storage facility to store a number of different products within the building at the same time or at different times.

The heat trace wire 28, 30 may be a cable that includes two wires separated by insulation. The insulation may be a meltable plastic. The plastic melts at a predetermined temperature causing the two wires to touch and short. When fire is present, the heat may melt the insulation between the two wires. With the insulation melted, the wires may contact one another and create a short. The short may be detected by the control panel 22 indicating a fire is present. The control panel 22 may actuate the valve or valves 26 closest to the affected region to allow the fire extinguishing material to flow to the discharge orifices 34 adjacent or near the fire.

The fire detection and extinguishing system 20 may include a main supply source of water, clean agents, CO2, wet chemical, or dry chemical agent. The fire detection and extinguishing system 20 may be pressurized or non-pressurized. The fire detection and extinguishing system 20 may be a wet system or a dry system. In a wet system, the supply line extension 36 and branch line 32 may be in a normally filled condition. That is, the fire extinguishing material may be present in the lines at all time. In a dry system, the supply line extension 36 and branch line 32 may be empty. The fire extinguishing material may be pressurized at the source or prior to the valve 26. Thus, when the valve 26 is opened, the pressurized fluid (e.g., pressurized water) may flow through the valve 26, branch line 32, and out the discharge orifices 34. Alternatively, the pipes may house pressurized air or nitrogen, and receive water upon fire detection. In embodiments where the pipes house pressurized air or nitrogen after the valve 26, the discharge orifices 34 may need to be plugged to maintain the pressure. Where a dry system is provided, it may be modular such that it may be moved. The piping of a dry system may or may not be pressurized.

Although the storage rack system 10 and the system 20 are depicted with a set number of components, more or fewer may be provided. For example, more or fewer discharge orifices 34, shelves 14, heat trace wires 28, 30, control panels 22, valves 26, etc., may be provided. In an exemplary embodiment, the vertical spacing between the lower heat trace wires 28a, 30a and the upper heat trace wires 28b, 30b may be 30 feet or 40 feet, however other vertical spacings are contemplated. According to an embodiment, it may be determined that sprinklers are required vertically approximately every 30 feet (as compared, for example, to conventional systems which may require sprinklers every 10 feet). Thus, if the racks are spaced approximately 10 feet apart vertically, the first two racks may include linear heat detection (and no piping/sprinklers) and the third rack may include piping and sprinklers. The linear heat detection cable may be included on the third rack as well. According to an embodiment, one or more shelves are installed vertically approximately every 10 feet within each storage rack, and one or more discharge orifices are installed vertically approximately every 30 feet within each storage rack. Simulations or testing may be performed to determine optimum spacing (both vertically and horizontally) of the linear heat detection and discharge orifices, to allow full fire protection coverage of the in-rack storage system.

Additionally, although depicted and described with a control panel 22 coupled to each storage rack system 10, the control panel 22 may instead be a central control panel electrically and communicatively coupled to all of the heat trace wires 28, 30 and signal wires 24 of each of the plurality of storage rack systems 10. Where a central control panel is included and/or where more than one valve 26 is provided on a storage rack system 10, the control panel may send opening instructions to one or more valves closest to the fire.

Although the linear detection system is described with heat trace wires, other types of heat detection may be provided, such as, for example, other heat detection systems, smoke detection, optical detection, etc. The fire detection and extinguishing system 20 is described for use in-rack with a storage rack system 10. However, the fire detection and extinguishing system 20 may be installed near or at a ceiling in a similar manner to a conventional ceiling-based system where pipes and sprinklers are distributed in a network throughout the ceiling of a building.

Additionally, the system may include a device, such as a “metron,” to initiate operation of the system once the system receives a signal from the detection and/or control system. The heat detection and valves may include communication capability that may be used for monitoring and reporting.

Accordingly, where a plurality of the storage rack systems 10 is provided, the heat trace wires 28, 30 allow for detection of fire in a finite area (e.g., the area of an individual storage rack system 10), thus allowing for the control panel 22 to activate the valve 26 of the particular storage rack system 10 where the fire is detected. The fire extinguishing material is applied to the area detected by the heat trace wires 28, 30 through the discharge orifices 34 of the particular storage rack system 10 where fire is detected. Thus, the inclusion of heat trace wires within the storage racks allows for reduced costs and reduced water or chemical flow as fluid is only provided to the finite area where fire is detected. This also results in reduction in the amount of product damaged by both the fire and the fire extinguishing material as it allows for earlier detection of fire and reduced area of fire extinguishing material application as compared to the conventional fire prevention systems previously described. Localized detection permits earlier detection and thus allows for extinguishing of a smaller fire. The inventive fire detection and extinguishing system further allows for a reduction in piping and discharge orifices (e.g., sprinklers) as compared to the conventional fire prevention systems previously described.

The in-rack fire detection and extinguishing system of the foregoing disclosure may be a zonal, in-rack piping system for delivering localized protection for a hazard early in the development of a fire. The system may include detectors, valves, piping, water discharge devices, and a control system. The detection may be installed throughout a hazard area, such as a rack storage arrangement. During normal operating conditions, the valves may prevent water flow (e.g., normally closed) to the hazard. Upon detection, specific valves may be operated to provide water to the area of detection. Control of the valves may be either integrated within the valve or operated by a control panel. The fire extinguishing material (e.g., water) may be applied to the hazard by sprinklers or nozzles. The control system may open one or more valves to deliver fire protection fluid through piping and discharge devices, directly at the area of fire growth, as located via the detection.

Early detection in combination with localized protection may be achieved with the foregoing described fire detection and extinguishing system. A few exemplary improvements provided by the inventive system include: detection installed throughout a hazard may enable early identification of fire and specific location of development; earlier detection may initiate fire protection when the fire is much smaller than what conventional protection is based on; required fire protection (e.g., water demand) may be lower; and using detection to initiate the system may allow for sprinklers and piping to be installed on greater spacing (horizontal and vertical), thus reducing installation costs. The inventive system may eliminate piping in areas that may be used for storage. This may increase the storage capability provided in a storage system.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A storage system comprising:
a storage rack system; and
a fire detection and extinguishing system, the fire detection and extinguishing system comprising:
a valve coupled to one or more discharge orifices; and
a linear heat detection system,
wherein the fire detection and extinguishing system is configured to detect a fire in the storage rack system and discharge a fire extinguishing material from the one or more discharge orifices to extinguish the fire.

2. The storage system of claim 1, wherein the linear heat detection system comprises one or more heat trace wires, the one or more heat trace wires configured to react to heat from the fire.

3. The storage system of claim 2, wherein the one or more heat trace wires are formed of two wires separated by a meltable plastic, wherein the meltable plastic is configured to melt at a predetermined temperature.

4. The storage system of claim 1, the storage rack system further comprising a forward frame and a rear frame, wherein the linear heat detection system is coupled to the forward frame and the rear frame.

5. The storage system of claim 1, further comprising a control panel coupled to the linear heat detection system and the valve.

6. The storage system of claim 5, wherein the linear heat detection system is configured to send a signal to the control panel that the fire is present and wherein the control panel is configured to send a signal to the valve to open.

7. The storage system of claim 6, wherein the signal sent to the control panel by the linear heat detection system is an electrical short.

8. The storage system of claim 1, wherein the storage rack system comprises a frame having an upper shelf and a lower shelf and wherein the linear heat detection system comprises a first heat trace wire.

9. The storage system of claim 8, wherein the first heat trace wire comprises an upper heat trace wire extending along an inner perimeter of the upper shelf and a lower heat trace wire extending along an inner perimeter of the lower shelf.

10. The storage system of claim 9, wherein the valve, one or more discharge orifices, and a branch line extend along only the upper shelf.

11. The storage system of claim 9, the storage rack system further comprising a first rack and a second rack, wherein the first heat trace wire is coupled to the first rack and the second rack.

12. The storage system of claim 1, wherein the fire extinguishing material is water, a wet chemical, or a dry chemical.

13. The storage system of claim 1, wherein the fire detection and extinguishing system is a dry system.

14. The storage system of claim 13, wherein one or more pipes in the dry system are pressurized with air or nitrogen.

15. A fire detection and extinguishing system, the system comprising:
a control panel;
a valve communicatively coupled to the control panel;
one or more discharge orifices in fluid communication with the valve; and
a linear heat detection system,
wherein the linear heat detection system is configured to detect a fire and the one or more discharge orifices are configured to discharge a fire extinguishing material onto the fire.

16. The fire detection and extinguishing system of claim 15, wherein the linear heat detection system comprises one or more heat trace wires.

17. The fire detection and extinguishing system of claim 16, wherein the one or more heat trace wires comprise a cable of two wires separated by a meltable plastic, the meltable plastic configured to melt at a predetermined temperature.

18. The fire detection and extinguishing system of claim 15, wherein the valve is configured to receive a signal from the control panel instructing the valve to open, thus allowing the fire extinguishing material to be discharged through the one or more discharge orifices.

19. The fire detection and extinguishing system of claim 15, wherein the fire detection and extinguishing system is configured to be installed on one or more storage racks.

20. A method for detection and extinguishing of a fire, the method comprising:
detecting heat from a fire with a linear heat detection system installed on one or more storage racks; and
discharging a fire extinguishing material from one or more discharge orifices installed on the one or more storage racks based on the detected heat.

21. The method of claim 20, wherein detecting heat from the fire comprises melting a meltable plastic between two wires thus causing the wires to short and send a signal to a control panel.

22. The method of claim 20, wherein the one or more storage racks comprise one or more shelves,
wherein the linear heat detection system is installed on every shelf, and
wherein the one or more discharge orifices are not installed on every shelf.

23. The method of claim 20, wherein discharging the fire extinguishing material further comprises sending a signal from a control panel to a valve to open the valve and flowing the fire extinguishing material through the valve and to the one or more discharge orifices.

24. The method of claim 20, wherein the linear heat detection system is installed on a roof above the one or more storage racks, and further comprising:
discharging a fire extinguishing material from one or more discharge orifices installed on the one or more storage racks based on the detected heat.

25. The storage system of claim 8, wherein the first heat trace wire further comprises:
an upper heat trace wire extending along an inner perimeter and an outer perimeter of the upper shelf; and
a lower heat trace wire extending along an inner perimeter and an outer perimeter of the lower shelf.
